(19) United States
(12) Patent Application Publication
(10) Pub. No.: US 2009/0210461 A1
(43) Pub. Date: Aug. 20, 2009

(54) Network Attached Storage System and Method

(76) Inventor: Austin McChord, Newtown, CT (US)

Correspondence Address: LAW OFFICE OF MICHAEL A. BLAKE, LLC, 95 HIGH STREET, SUITE 5, MILFORD, CT, 06460, US

(21) Appl. No.: 12/031,034

(22) Filed: Feb. 14, 2008

(51) Int. Cl. G06F 17/30

(52) U.S. Cl. 707/204; 707/E17.032

(57) ABSTRACT

A network attached storage system comprising: a computer; a network in signal communication with the computer; a network attached storage device in signal communication with the network, and not physically connected to the computer; an internet in signal communication with the network; a storage server remotely located from the computer, the network attached storage device, and the network, the storage server in signal communication with the internet; a sync server remotely located from the computer, the network attached storage device, and the network, and the sync server in signal communication with the internet; where the network attached storage device is configured to store data, and where the network attached storage device is further configured to periodically communicate with the storage server and backup the data to the storage server. A method for backing up data to a remote location, the method comprising: setting a counter N to 1; attaching an Nth network attached storage device to an Nth network; storing data on the Nth network attached storage device; backing up data, periodically, from the Nth network attached storage device to a remote storage server; determining whether N is equal to the total number of network attached storage devices to be put in operation; managing all of the network attached storage devices with a remote sync server, if N is equal to the total number of network attached storage devices to be put in operation; determining whether there is a data replacement request from a user; locating the data on the storage server, if there is a data replacement request from the user; sending data replacement to the user; determining whether a new network attached storage device is to be put into operation; and advancing counter by 1, if there is a new network attached storage device to be put into operation.

### TECHNICAL FIELD

The present invention relates to data storage systems, and more particularly to a network attached data storage system.

### BACKGROUND

With the vast technological advances being made, many computers, including home and small business computers are operated on a network. Data on these computers should be safeguarded using data backup systems. Data backup systems may be very complicated and difficult for the average user to use. Some data backup systems require a complicated installation of backup software as well as requiring the configuration of the backup system that can be thoroughly confusing and complicated. Another disadvantage of current backup systems, is that many of them use computer resources that can slow down the operation of the computer and/or applications running on the computer. Current remote backup systems can take a very long time to backup the data on a computer (sometimes the backup can take up to 30 days or more). Additionally, some backup systems may have compatibility issues with a particular type of computer that is being backed up, or the network that the computer resides on.

Therefore, a network attached storage system that overcomes the above and other disadvantages is desired.

### SUMMARY

The disclosed invention relates to a network attached storage system comprising: a computer; a network in signal communication with the computer; a network attached storage device in signal communication with the network, and not physically connected to the computer; an internet in signal communication with the network; a storage server remotely located from the computer, the network attached storage device, and the network, the storage server in signal communication with the internet; a sync server remotely located from the computer, the network attached storage device, and the network, and the sync server in signal communication with the internet; where the network attached storage device is configured to store data, and where the network attached storage device is further configured to periodically communicate with the storage server and backup the data to the storage server.

The discloses invention also relates to a method for backing up data to a remote location, the method comprising: setting a counter N to 1; attaching an Nth network attached storage device to an Nth network; storing data on the Nth network attached storage device; backing up data, periodically, from the Nth network attached storage device to a remote storage server; determining whether N is equal to the total number of network attached storage devices to be put in operation; managing all of the network attached storage devices with a remote sync server, if N is equal to the total number of network attached storage devices to be put in operation; determining whether there is a data replacement request from a user; locating the data on the storage server, if there is a data replacement request from the user; sending data replacement to the user; determining whether a new network attached storage device is to be put into operation; and advancing counter by 1, if there is a new network attached storage device to be put into operation.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a simple schematic diagram of one embodiment of the disclosed system;

FIG. 2 is a more detailed schematic diagram of the disclosed system from FIG. 1;

FIG. 3 is a flowchart illustrating one embodiment of the disclosed method.

### DETAILED DESCRIPTION

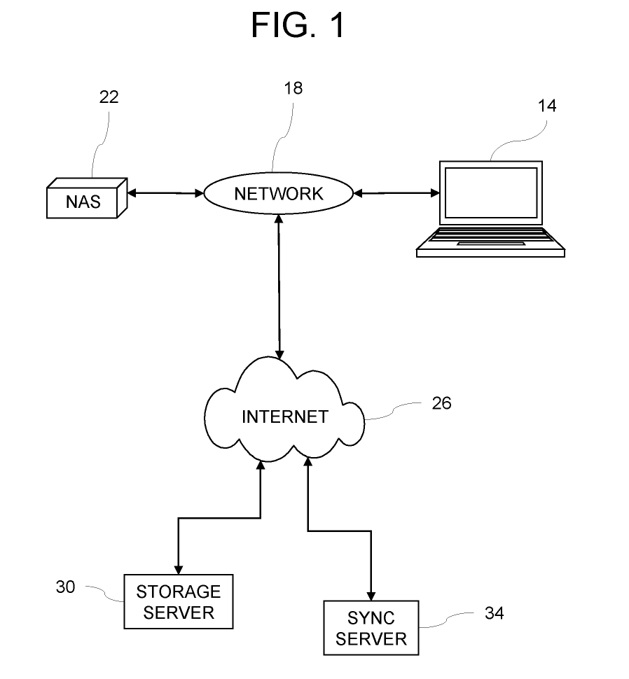

FIGS. 1 is a simple schematic diagram that illustrates one embodiment of the disclosed network attached storage system 10. In this embodiment, the system comprises a computer 14, a network 18 in signal communication with the computer, and the network attached storage device 22 in signal communication with the network. The computer 14 comprises a standard computer such as a minicomputer, a microcomputer, a UNIX® machine, mainframe machine, personal computer (PC) such as INTEL®, APPLE®, or SUN® based processing computer, or other appropriate data processing means. The computer 14 may also include typical components (mostly not shown), such as a motherboard, central processing unit (CPU), random access memory (RAM), hard disk drive, display adapter, other storage media such as diskette drive, CD-ROM, flash-ROM, tape drive, PCMCIA cards and/or other removable media, a monitor (shown), keyboard (shown), mouse and/or other user interface means, a modem, network interface card (NIC), and/or other conventional input/output devices. The computer 14 will have user's data that the user wishes to backup and may use Samba for file transfer with the network attached storage device 22. HTTP may be used for administration of users and shares. A network share is a particular folder or location in which data can be copied to. Shares can be configured with varying permissions for different users on a network. The network 18 may be a network currently known or that may be developed in the future. Such currently known networks include, but are not limited to: a Personal Area Network (PAN), and a Local Area Network (LAN). The network attached storage device 22 is configured to communicate directly with the network 18. The network attached storage device 22 is configured to not attach directly to the computer 14, and does not use computer 14 resources. The network attached storage device 22 will have a central processing unit (CPU) and a hard drive. The network attached storage device 22 may also have memory. In one embodiment, the CPU may be an about 266 MHz ARM Processor, the memory may be about 32 MB Ram, and the hard drive may be an about 100 GB to an about 1000 GB hard drive. Larger hard drives may also be used in the network attached storage device 22 as they become available. In addition other storage media, other than a hard drive, may be used in the network attached storage device 22, such media may include but are not limited to: Arrays of nanowires, patterns of electric charges or magnetic particles stamped into thin films of plastic, holograms, single or small groups of molecules, including carbon nanotubes. The network 18 is in signal communication with the Internet 26. In signal communication with the internet is a storage server 30 and a sync server 34. The storage server 30 and sync server 34 may be remotely located from the computer 14, network 18, and network attached storage device 22. “Remotely” in this patent application will normally mean located a mile or more away. The storage server is configured to hold copies of one or more user's data and is further configured to restore the data in the even of a network attached storage device 22 failure, and thus is a data repository. The sync server is configured to manage one or more network attached storage device 22, handle user's accounts, security, billing, software updates, as well as other management functions. The storage server 30 may comprises a central processing unit (CPU), random access memory (RAM), hard disk drive, display adapter, other storage media such as diskette drive, CD-ROM, flash-ROM, tape drive, PCMCIA cards and/or other removable media, a modem, network interface card (NIC), and/or other conventional input/output devices. Similarly, the sync server 34 may comprises a central processing unit (CPU), random access memory (RAM), hard disk drive, display adapter, other storage media such as diskette drive, CD-ROM, flash-ROM, tape drive, PCMCIA cards and/or other removable media, a modem, network interface card (NIC), and/or other conventional input/output devices.

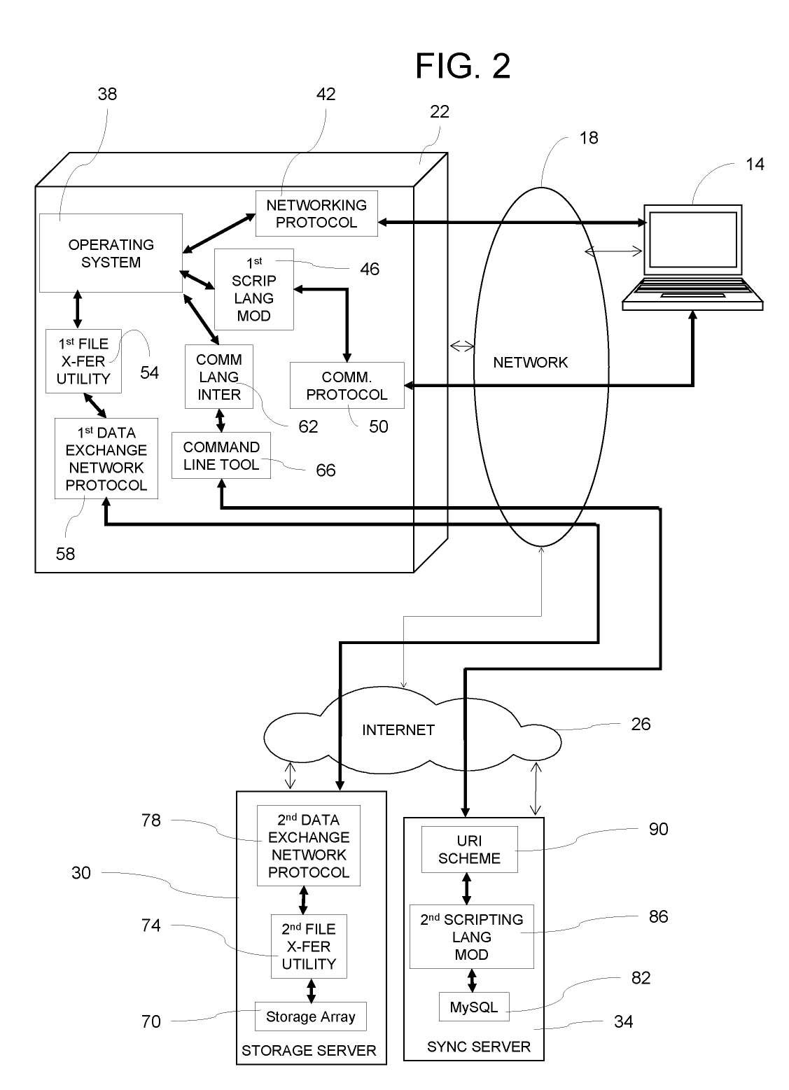

FIG. 2 is a more detailed schematic diagram that illustrates one embodiment of the disclosed network attached storage system 10. In this figure, one can see that the network attached storage device 22 comprises several sub-systems, including an operating system 38. The operating system may the Debian operating system known for being composed generally of free software. Its primary form, Debian GNU/Linux, is a popular and influential Linux distribution. Of course other operating systems may be used, including but not limited to Windows®, and MAC OS®, and UNIX®. The operating system 38 is in signal communication with a networking protocol 42. The networking protocol 42 used in the current embodiment may include, but is not limited to following list of versions of suitable networking protocols: Samba; Samba TNG: a fork of Samba; the Linux kernel which includes two SMB client implementations that use the Linux VFS, providing access to files on an SMB server through the standard file system API: smbfs and cifs; n SMB implementation offered ONStor Inc.; Novell NetWare version 6 and newer's CIFS server implementation; FreeBSD's SMB client implementation called smbfs; NetBSD's and Mac OS X's SMB client implementations called smbfs; Solaris's CIFS client for Solaris; OpenSolaris's in-kernel CIFS server; Sun Microsystems Cascade, which became known as PC-Netlink; FreeNAS; Advanced Server for Unix (AS/U); VERITAS Software's implementation of SMB; SCO; SCO's VisionFS; Network Appliance's SMB server implementation; Objective Development's Sharity's SMB file-system client for Unix; The Alfresco content-management system's Java implementation of SMB; JCIFS's implementation of SMB in Java; RTSMB; Visuality Systems NQ CIFS; Thursby Software Systems' implementation of SMB/CIFS for Mac OS. Also in signal communication with the operating system is a first scripting language module 46. The first scripting language module 46 may be PHP, or an other scripting language module such as, but not limited to: Java, ASP, and Ruby on Rails. In signal communication with the first scripting language module 46 is a communications protocol 50 such as HTTP. Of course other communications protocols may be used, such as, but not limited to: NFS, AFP (Apple File Protocol), FTP, SNMP. Also in signal communication with the operating system 38, is a first file transfer utility 54. The first file transfer utility 54 may be the UNIX software application Rsync. Other file transfer utilities may be used, such as, but not limited to: UNISON, SCP, CP, AFBACKUP, or UBT. In signal communication with the first file transfer utility 54 is a first data exchange network protocol 58. The first data exchange network protocol 58 may be a secure shell (SSH) protocol. Other data exchange network protocols may be used. Such protocols include, but are not limited to: OPENVPN, VPN's in general, TELNET. A command language interpreter 62 is also in signal communication with the operating system 38. The command language interpreter 62 may be the BASH Shell. Other command language interpreters may be used, including but not limited to: TCSH, CSH, SH, DOS. A non-exhaustive list of command language interpreters can also be found at http://www.luv.asn.au/overheads/shells-talk.html. In signal communication with the command language interpreter 62 is a command line tool for transferring files 66. The command line tool 66 may be cURL.

The storage server 30 comprises a storage array 70. The storage array may be any suitable storage array currently known, including, but not limited to: NAS, Modular SAN arrays, Monolithic SAN arrays, Storage Virtualization and Utility SAN Arrays. The storage array 70 is in signal communication with a second file transfer utility 74. The second file transfer utility 74 may be the UNIX software application Rsync. Other file transfer utilities may be used, such as, but not limited to: UNISON, SCP, CP, AFBACKUP, or UBT. In signal communication with the second file transfer utility 74 is a second data exchange network protocol 78. The second data exchange network protocol 58 may be a secure shell (SSH) protocol. Other data exchange network protocols that may be used include, but are not limited to: TELNET, OPENVPN, and RSYNC (which has its own communication protocol). The sync server 34 comprises a database management system 82. The database management system 82 may be any of the following non-limiting list of database management systems: MySQL, Oracle, DB2, Microsoft Access, Microsoft SQL Server, Firebird, PostgreSQL, SQLite, FileMaker and Sybase Adaptive Server Enterprise. The database management system 82 is in signal communication with a second scripting language module 86. The second scripting language module 86 may be PHP, or an other scripting language module such as, but not limited to: Java, ASP, and Ruby on Rails. The second scripting language module 86 is in signal communication with a URI scheme 90 such as, but not limited to HTTPS.

The networking protocol 42 communicates with the computer 14 through the network 18 (as shown by the arrow). Source data can be transferred from the computer 14 to the network attached storage device 22 via the networking protocol 42 and stored as backup data on the network attached storage device 22. A user can configure and administer the backup system 10 through his computer 14. This is because the computer 14 can communicate through the network 18 with the communications protocol 50 in the network attached storage device 22. A backup copy of data from the network attached storage device 22 can be transferred from the network attached storage device 22 through the first data exchange network protocol 58 through the network 18, and on through the internet 26, and then through to the second data exchange network protocol 78 located in the storage server 30. Here in the storage server 30, backup data is stored, and sent to the user if there is a catastrophic failure of the network attached storage device 22. The data can be sent to the user via the internet, or can be shipped on a CD or DVD, or other storage media to the user. The command line tool 66 of the network attached storage device 22 is in signal communication with the URI Scheme 90 located in the sync server 34. The command line 66 communicates with the URI scheme 90 via the network 18 and the internet 26. Via this connection, the sync server is able to manage the network attached storage device 22 and all other network attached storage devices 22 connected to the internet The sync server 34 can also manage user accounts, security, billing, software updates as well as other management functions.

The disclosed network attached storage system 10 copies any data stored on a network attached storage devices 22 to an offsite location, the storage array 30. The user simply copies data to the network attached storage device 22. This data is transparently backed up remotely, where the storage array 30 is located. In one disclosed embodiment, the user can work off the computer's hard drive, and using his computer's already installed backup software (such as the backup utility that comes with the windows operating system), set up his computer to automatically back up to the network attached storage devices 22. In another disclosed embodiment, the user can simply have his source data reside directly on the network attached storage device 22, and thus his source data will automatically be remotely backed up, without the user having to do anything more. One of ordinary skill in the art will recognize that the storage server is a data repository. The types of data repository that the storage server may include, but are not limited to are: Unstructured; Full+Incrementals; Full+Differential; Mirror+Reverse Incrementals; and Continuous data protection.

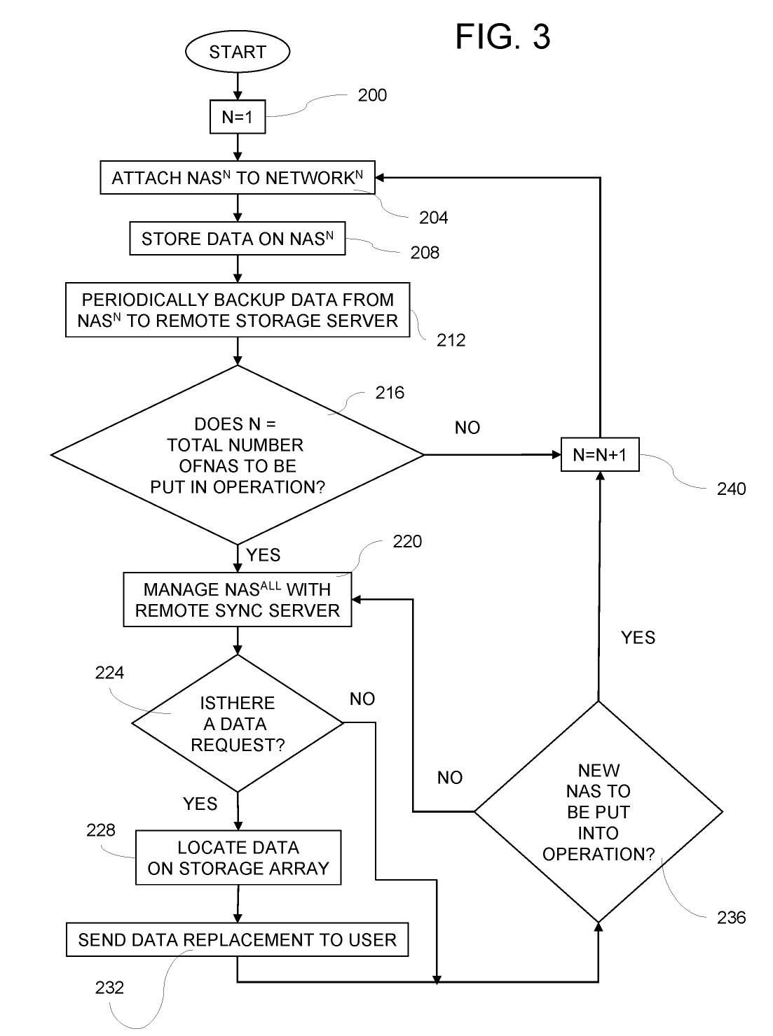

FIG. 3 is a flowchart of the disclosed method of the invention. Act 200 is a counter that sets the variable N to a value of 1. Act 204, the user attaches his particular network attached storage device (NAS) to his particular network. The superscript “N” is used to point out that many network attached storage devices and networks may be part of this disclosed system. At act 208, the user stores data on the network attached storage device. The user may accomplish this in a variety of ways, including, but not limited to using the backup utility that comes with his computer to periodically backup his data to the network attached storage device, or the user may configure his computer system such that his source data resides on the network attached storage device. At act 212, the data on the network attached storage device is periodically backed-up to the remote storage server. It should be pointed out that this act does not use any resources of the user's computer. At query 216, the system determines whether N yet equals the total number of NAS's to be put in operation. If the answer is “no”, at act 240 the counter is advanced by 1, and steps 204 through 216 are repeated. At act 224, all of the NAS's (which is represented by NASALL) are managed by the remote sync server. At query 224 the system determines whether a user has made a request for data from the storage array that had been saved on a particular NAS. A request for data may be made by the user if there has been a failure of his NAS, such a failure may be caused by, but not limited to: a catastrophe at the user's location (fire, earthquake, theft, etc), a failure of the NAS, a failure of the user's network, a failure of the user's computer. A request for data may be made for any other reason also. At act 228, the system locates the location of the data on the storage array. At act 232 the replacement data is sent to the user associated with the particular NAS that had the original copy of the data. The replacement data may be saved on a storage media and sent to the user by mail, or delivery service. In another embodiment, the data may be transmitted over the internet to the user. At query 236 the system determines whether a new NAS has been added to the system, and if so, the counter is advanced by one at act 240, and steps 204 through 216 are repeated. The NAS may use compression (ZIP, BZ2) to reduce the transfer times over the internet to the remote storage server.

Some advantages of this disclosed network attached storage system are that a physical hardware device plugs into your network, no software needs to be installed on the computer 14, and the disclosed system is compatible with any operating system that supports SAMBA file transfer. (Samba is the standard method used by windows, but is also supported by Linux systems, and apple systems.) In addition multiple computers can add files to the NAS allowing one NAS to backup many computers. Also, the disclosed network attached storage system 10 may be used with 3rd party backup software if desired. The prior art process of backing the data up over the internet can take a long time (30 days or more for lots of data), however the disclosed network attached storage system 10 is much quicker. Copying to the NAS from a network attached computer 14 may be about 100 times faster than backing up a computer using an online backup service. The time it takes for the NAS to send a copy to a remote storage server is comparable to other online backup systems, however, the benefit is that this process is handled entirely in background by the NAS. Therefore the user's computer 14 does not need to be on, nor are any of its resources being used during the up to 30 days it takes to fully synchronize with the remote storage server. Also, once a user a copies his data to the network attached storage devices 22, the computer 14 does not need to be left on for the remote location backup to work. The disclosed network attached storage system 10 uses very little computer resources.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A network attached storage system comprising:
a computer;
a network in signal communication with the computer;
a network attached storage device in signal communication with the network, and not physically connected to the computer;
an internet in signal communication with the network;
a storage server remotely located from the computer, the network attached storage device, and the network, the storage server in signal communication with the internet;
a sync server remotely located from the computer, the network attached storage device, and the network, and the sync server in signal communication with the internet;
wherein the network attached storage device is configured to store data, and wherein the network attached storage device is further configured to periodically communicate with the storage server and backup the data to the storage server.

2. The network attached storage system of claim 1, wherein the network attached storage device comprises:
an operating system;
a networking protocol in signal communication with the operating system;
a first scripting language module in signal communication with the operating system;
a communications protocol in signal communication with the scripting language module;
a first file transfer utility in signal communication with the operating system;
a first data exchange network protocol in signal communication with the first file transfer utility;
a command language interpreter in signal communication with the operating system; and
a command line tool for transferring files in signal communication with the command language interpreter.

3. The network attached storage system of claim 1, wherein the storage server comprises:
a storage array;
a second file transfer utility in signal communication with the storage array; and
a second data exchange network protocol in signal communication with the file transfer.

4. The network attached storage system of claim 1, wherein the sync server comprises:
a database management system;
a second scripting language module in signal communication with the database management system; and
a URI scheme in signal communication with the scripting language module.

5. The network attached storage system of claim 2, wherein the operating system is selected from the group consisting of Debian; Windows®, and MAC OS®, and UNIX sync server.

6. The network attached storage system of claim 2, wherein the networking protocol is selected from the group consisting of Samba, Samba TNG; smbfs and cifs; ONStor Inc. SMB implementation; Novell NetWare version 6 and newer's CIFS server implementation; FreeBSD's smbfs; NetBSD's smbfs; Mac OS X's smbfs; Solaris's CIFS client; OpenSolaris added in-kernel CIFS server support; PC-Netlink's Advanced Server for Unix; CIFS/Samba; VERITAS Software's SMB; SCO's port of Advanced Server for Unix; VisionFS; Network Appliance's SMB server implementation; Objective Development's Sharity; The Alfresco content-management system's Java implementation of SMB; JCIFS's implementation of SMB in Java; RTSMB's CIFS/SMB implementation written in ANSI C; and Visuality Systems NQ CIFS; Thursby Software Systems' SMB/CIFS for Mac OS.

7. The network attached storage system of claim 2, wherein the scripting language module is selected from the group consisting of PHP, ASP, and Ruby on Rails.

8. The network attached storage system of claim 2, wherein the communications protocol is HTTP.

9. The network attached storage system of claim 2, wherein the first file transfer utility is Rsync.

10. The network attached storage system of claim 2, wherein the first data exchange network protocol is SSH.

11. The network attached storage system of claim 2, wherein the command language interpreter is BASH Shell.

12. The network attached storage system of claim 2, wherein the command line tool is cURL.

13. The network attached storage system of claim 3, wherein the storage array is selected from the group consisting of NAS, Modular SAN arrays, Monolithic SAN arrays, Storage Virtualization, and Utility SAN Arrays.

14. The network attached storage system of claim 3, wherein the second file transfer utililty is Rsync.

15. The network attached storage system of claim 3, wherein the second data exchange network is SSH.

16. The network attached storage system of claim 4, wherein the database management system is selected from the group consisting of MySQL, Oracle, DB2, Microsoft Access, Microsoft SQL Server, Firebird, PostgreSQL, SQLite, FileMaker and Sybase Adaptive Server Enterprise.

17. The network attached storage system of claim 4, wherein the second scripting language module is selected from the group consisting of PHP, ASP, and Ruby on Rails.

18. The network attached storage system of claim 4, wherein the URI scheme is HTTPS.

19. A method for backing up data to a remote location, the method comprising:
setting a counter N to 1;
attaching an N^{th} network attached storage device to an N^{th} network;
storing data on the N^{th} network attached storage device;
backing up data, periodically, from the N^{th} network attached storage device to a remote storage server;
determining whether N is equal to the total number of network attached storage devices to be put in operation;
managing all of the network attached storage devices with a remote sync server, if N is equal to the total number of network attached storage devices to be put in operation;
determining whether there is a data replacement request from a user;
locating the data on the storage server, if there is a data replacement request from the user;
sending data replacement to the user;
determining whether a new network attached storage device is to be put into operation; and
advancing counter by 1, if there is a new network attached storage device to be put into operation.
